(19) United States
(12) Patent Application Publication
(10) Pub. No.: US 2013/0185658 A1
(43) Pub. Date: Jul. 18, 2013

(54) Portable Electronic Device, Content Publishing Method, And Prompting Method

(71) Applicants: Ran Sun, Beijing (CN); Ming Cai, Beijing (CN); Lei Lv, Beijing (CN)

(72) Inventors: Ran Sun, Beijing (CN); Ming Cai, Beijing (CN); Lei Lv, Beijing (CN)

(73) Assignee: Beijing Lenovo Software Ltd., Haidian District, Beijing (CN)

(21) Appl. No.: 13/877,232

(22) PCT Filed: Sep. 27, 2011
(86) PCT No.: PCT/CN2011/080209

§ 371 Date: Apr. 1, 2013

(30) Foreign Application Priority Data
Sep. 30, 2010 (CN) 201010501947.2
Sep. 30, 2010 (CN) 201010501957.6

(51) Int. Cl. H04L 29/08

(52) U.S. Cl. CPC H04L 67/02
USPC 715/753

(57) ABSTRACT

A portable electronic device, a method for content publishing using the portable electronic device, and a prompting method for content selection are described. The electronic device includes a display unit to display to an user; an acquirement unit for content data acquirement; a selection unit for selecting at least one destination address for content data publishing; and a transmission unit for transmission of content data based on a destination address containing content data for external visits.

### BACKGROUND

The present disclosure relates to a portable electronic device, a content publishing method for the portable electronic device and a prompting method for content selection.

In recent years, a variety of portable electronic devices such as digital camera, portable cell phone, portable music player and so on are widely applied. The types of services that the portable electronic devices can provide to a user are increasingly diversified. Taking a portable cell phone as an example, besides traditional voice calling and short messaging, many of the present portable cell phones are also provided with multiple functions such as music playing, video playing, photographing and shooting and wireless internet accessing and so on.

On the other hand, with the development of the Internet, the contact ways between people are transforming from contact-centered communication applications to content-centered social network services. For example, an increasing number of people now select publish their diaries and take a photograph by means of social network, blog and micro blog and so on rather than merely by means of short message, multimedia message and phone and so on to share with their friends.

At present, proposed is a portable electronic device being capable of connecting to a wireless network so as to log in social network, blog and micro blog and other websites to publish information. However, at each publication of information, users need to firstly log in their own publishing websites, then they can update information. Moreover, for the users who have multiple websites to publish their established contents or forward contents established by others for external visits, they need to log in their all websites being capable of publishing contents one by one when publishing contents, so as to update the published contents on the websites one by one, which causes inconvenience to operations of the user.

### SUMMARY

Due to the problem mentioned above, it is desired to provide a portable electronic device being capable of achieving a uniform content establishment and publication and a content publishing method for the portable electronic device.

According to an embodiment of the present disclosure, provided is a portable electronic device, comprising: a display unit for displaying to a user; an acquirement unit for acquiring content data; a selection unit for selecting at least one destination address for publishing the content data; a transmission unit for transmitting the content data according to the destination address, wherein the destination address is used to store the content data for external visits.

According to another embodiment of the present disclosure, provided is a content publishing method for a portable electronic device, comprising: acquiring content data; selecting at least one destination address for publishing the content data; transmitting the content data according to the destination address, wherein the destination address is used to store the content data for external visits.

According to another embodiment of the present disclosure, provided is a portable electronic device, comprising: a publication board unit; a display unit for displaying to a user; and a transmission unit for transmitting content data according to a destination address selected by a selection module, wherein the publication board unit comprises: at least one content establishment module for establishing at least one type of content data; a selection module for selecting at least one destination address for publishing the content data, wherein the destination address is used to store the content data for external visits.

According to another embodiment of the present disclosure, provided is a portable electronic device, comprising: a display unit for displaying at least two parts of contents with a first effect; an identification unit for identifying whether there is extractable content that can be extracted in the at least two parts of contents; and a publication board unit, comprising: at least one content establishment module for establishing at least one type of content data; and a content extraction module for extracting the content data from the displayed at least two parts of contents, wherein the publication board unit enters into a first operating state, when the identification unit identifies that there is extractable content in the at least two parts of contents; and the publication board unit enters into a second operating state, when the identification unit identifies that there is no extractable content in the at least two parts of contents.

According to another embodiment of the present disclosure, provided is a prompting method for content selection applied to a portable electronic device with a display unit. The method comprises: acquiring at least two parts of contents; identifying extractable content that can be extracted in the at least two parts of contents; and displaying the extractable content on the display unit with a second effect and displaying unextractable content that cannot be extracted in the at least two parts of contents with a third effect.

The portable electronic device and the content publishing method for the portable electronic device according to the embodiments of the present disclosure are capable of conveniently and quickly establishing or extracting the content data to be published, for example, a user is able to quickly put the content watched in the portable electronic device into a publication unit or can establish in the publication unit a variety of media files such as text, picture, video and audio and so on and share the above content data at multiple destinations such as information, mail, micro blog, social network and instant messaging (IM) and so on, so as to achieve a uniform establishment and publication of the published content.

In addition, according to the prompting method of the embodiments of the present disclosure, when making a selection of contents, the user can clearly recognize identifiable content and unidentifiable content, so as to make it convenient for a user to further perform the selection operation.

### BRIEF DESCRIPTION OF THE DRAWINGS

In order to more explicitly specify the technical solutions of the embodiments of the present disclosure, below will be a brief introduction of the accompanying drawings needed to be used in the description of the present embodiments. The accompanying figures described below are merely exemplary embodiments of the present disclosure.

FIG. 1 shows an exemplary block diagram of a structure of a portable electronic device according to an embodiment of the present disclosure.

FIG. 2 shows an exemplary block diagram of a structure of a portable electronic device according to another embodiment of the present disclosure.

FIG. 3 shows an exemplary block diagram of a structure of a portable electronic device according to another embodiment of the present disclosure.

FIG. 4 shows an exemplary block diagram of a structure of a portable electronic device according to another embodiment of the present disclosure.

FIG. 5a shows an exemplary diagram of a user interface of a publication board unit displayed on a display unit without establishing content data.

FIG. 5b shows an exemplary diagram of establishing an image type of content data through an image content establishment module.

FIG. 5c shows an exemplary diagram of a user interface of a publication board unit displayed on a display unit in a case of having established an image type of content data.

FIG. 6 shows an exemplary block diagram of a structure of a portable electronic device according to another embodiment of the present disclosure.

FIG. 7 describes a flow diagram of a content publishing method according to an embodiment of the present disclosure.

FIG. 8 describes a flow diagram of a prompting method for content selection according to an embodiment of the present disclosure.

FIG. 9 describes a flow diagram of a prompting method for content selection according to another embodiment of the present disclosure

### DETAILED DESCRIPTION

The preferable embodiments of the present disclosure will be described in detail by referring to the accompanying drawings. It shall be noted that, in the present specification and accompanying figures, the same reference sign is given to the units that basically possess the same steps and elements, and repetitive descriptions about the same steps and elements will be omitted.

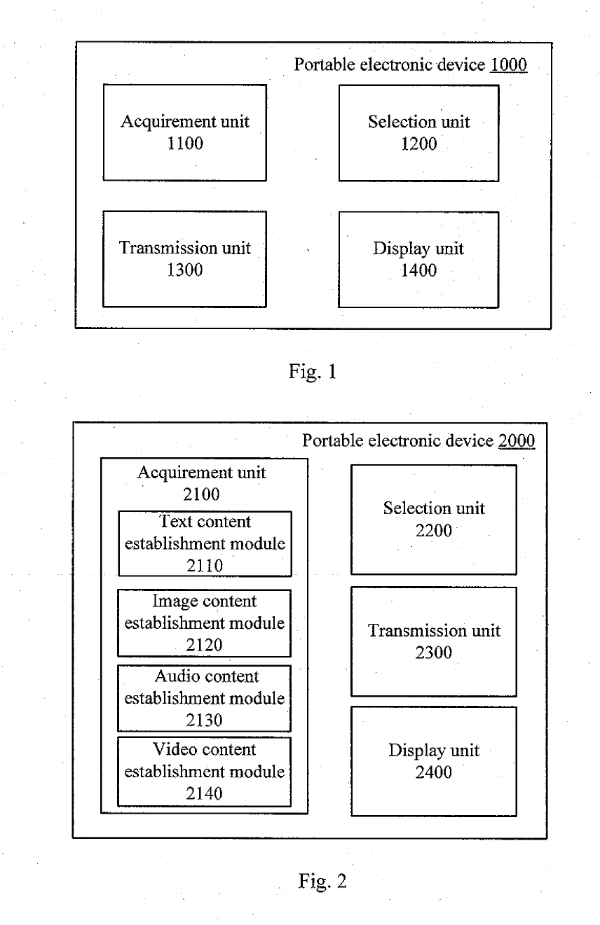

Below, a description will be given to a portable electronic device of an embodiment of the present specification by referring to FIG. 1. FIG. 1 shows an exemplary block diagram of a structure of a portable electronic device 1000 according to an embodiment of the present disclosure. As shown in FIG. 1, the portable electronic device 1000 of the present embodiment comprises: an acquirement unit 1100, a selection unit 1200, a transmission unit 1300 and a display unit 1400. The acquirement unit 1400 can acquire content data. The content data may be text, image and video and so on. The specific content of the content data does not compose a limitation to the present disclosure. For example, the acquirement unit 1100 can acquire the newly established content data of the user, and also can extract the content data when the user browses the content data of text, image or video and so on. Later, there will be a detailed description for this.

The selection unit 1200 can select at least one destination address for publishing the content data. The destination address is used to store the content data for external visits. The destination address may be a website corresponding to personal spaces of a user on social Networks (for example, Renren, Kaixin and so on), a website corresponding to a blog or micro blog of the user, or mail address and so on. In addition, the selection unit 1200 can also select to send the content data by means of short messages.

The transmission unit 1300 transmits the content data according to the destination address, so that friends of the user or other people also can externally visit the content published by the user, for example. The selection unit 1200 may select a single destination address or select multiple destination addresses. The transmission unit 1300 can transmit the content dada to the selected one or multiple destination addresses at the same time. Besides the destination addresses being used for storing the content data for external visits, the selection unit 1200 can be further used for selecting a telephone number of contacts stored in the portable electronic device 1000 and transmitting the acquired content data through the transmission unit 1300.

In particular, after the user have selected the destination address, the selection unit 1200 can determine whether the user have selected to publish the content data by means of mail or short message. It should be noted that, the step of determining whether the user have selected to publish the content data by means of mail or short message can also be performed for example by other modules of the transmission unit 1300. If the user does not select to publish the content data by means of mail and/or short message, the transmission unit 1300 transmits the content data according to the destination address; if the user selects to publish the content data by means of mail and/or short message, a list of contacts is displayed on the display unit 1400, so as to make it convenient for the user to select a contact. Then, the transmission unit 1300 transmits the content data according to for example the website according to the personal space of the user on social networks, the website corresponding to the blog and micro blog of the user, the destination address indicated by the mail address and/or the telephone number selected by the user.

The display unit 1400 is used for displaying to the user. The display unit 1400 can comprise a display screen of a type such as TFT, OLED and so on, and can also comprise a low power display screen such as a display screen of a type such as Memory LCD, E-Ink and so on. The specific type of the display screen in the display unit 1400 does not compose a limitation to the present disclosure.

In addition, after the acquirement unit 1100 has acquired the content data, the user can select the destination address stored in a storage (not shown) through the selection unit 1200. Alternatively, the selection unit 1200 further can select according to the acquired content data at least one destination address being capable of publishing the content data. In particular, different addresses may have different restrictions and requirements for the content data stored therein for external visits. For example, many micro blog websites restrict the number of words of the text published at one time, while some social networking websites may not allow the user to publish any video data. When the acquirement unit 1100 acquires the content data, it can acquire format information of the content data (for example format and size of the content data) at the same time. The selection unit 1200 can read format restrictions of candidate destination addresses stored in the storage one by one, and in turn compare the acquired format information of the content data with the format restrictions of the candidate destination addresses, so as to determine whether the acquired content data exceeds the format restrictions. Alternatively, the acquired format information of the content data can also be compared with the format restrictions of each candidate destination addresses at the same time. According to a determination result of the selection unit 1200, the display unit 1400 can display to the user the candidate destination address, the publishing requirements of which are met by the acquired content. Alternatively, the display unit can display with different display effects the candidate destination addresses the publishing requirements of which are met and the candidate destination addresses the publishing requirements of which are not met, for example, displaying with a first luminance the candidate destination addresses the publishing requirements of which are met while displaying with a second luminance the candidate destination addresses the publishing requirements of which are not met by the acquired content.

In the alternative embodiments, the portable electronic device further comprises a processing unit. The processing unit can process the content data according to the publishing requirements of the destination addresses selected by the selection unit. For example, when the acquirement unit has acquired the content data, it can acquire the format information of the content data at the same time. According to the format restrictions corresponding to the destination addresses selected by the user through the selection unit, the processing unit processes the content data and the transmission unit transmits the processed content data to the corresponding destination address. In particular, the processing unit can determine whether the text exceeds the restrictions, respectively, and remove a part of the text exceeding the restrictions and replace with an ellipsis if the text exceeds the restrictions; determine whether the destination address does not support a video format, automatically extract screenshots of the video at the beginning, end and/or middle time period as the published image data if the destination address does not support the video format; determine whether a picture or a video exceeds the restrictions, compress the picture or the video if the picture or the video exceeds the restrictions; and determine whether there is content exceeding the format, remove the part of content exceeding the format if there is content exceeding the format.

Below, a description will be given to a portable electronic device of another embodiment of the present specification by referring to FIG. 2. FIG. 2 shows an exemplary block diagram of a structure of a portable electronic device 2000 according to another embodiment of the present disclosure. As shown in FIG. 2, similar to the electronic device 1000, the electronic device 2000 comprises: an acquirement unit 2100, a selection unit 2200, a transmission unit 2300 and a display unit 2400. The selection unit 2200, the transmission unit 2300 and the display unit 2400 are respectively similar to the selection unit 1200, the transmission unit 1300 and the display unit 1400 of the electronic device 1000 as shown in FIG. 1. In particular, the selection unit 2200 can select at least one destination address for publishing content data. The transmission unit 2300 transmits the content data according to the destination address selected by the selection unit 2200. The display unit 2400 is used for displaying to the user.

The acquirement unit 2100 in the present embodiment can further comprises at least one content establishment module for establishing at least one type of content data. As shown in FIG. 2, the at least one content establishment module can comprise a text content establishment module 2110, an image content establishment module 2120, an audio content establishment module 2130 and/or a video content establishment module 2140. More particularly, the image content establishment module 2120 and the video content establishment module 2140 can comprise a camera so as to establish image and video data to be published. The audio content establishment module 2130 can comprise a microphone so as to establish video data to be published.

In addition, the content establishment module can further edit the established content data. In particular, the text content establishment module 2110 can perform operations of inserting and deleting and the like on the established text data. The image content establishment module 2120, the audio content establishment module 2140 and the video content establishment module 2140 can perform operations of compressing or deleting the established content data and adding a theme for the established content data. The user can select a content establishment module according to his/her own preferences so as to establish a corresponding type of content data.

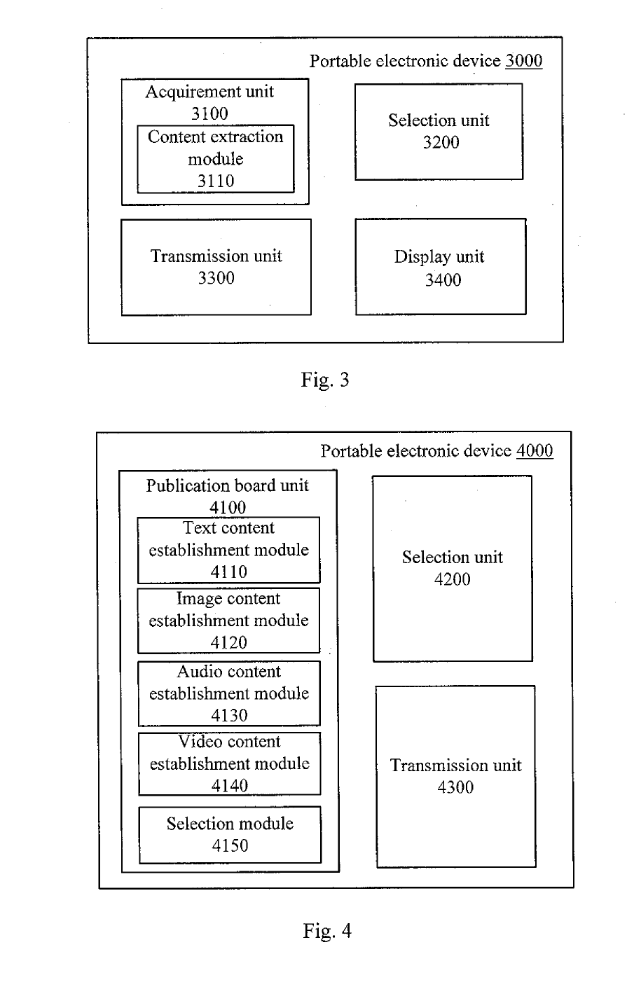

Below, a description will be given to a portable electronic device of another embodiment of the present specification by referring to FIG. 3. FIG. 3 shows an exemplary block diagram of a structure of a portable electronic device 3000 according to another embodiment of the present disclosure. As shown in FIG. 3, similar to the electronic device 1000, the electronic device 3000 comprises: an acquirement unit 3100, a selection unit 3200, a transmission unit 3300 and a display unit 3400. The selection unit 3200 and the transmission unit 3300 are respectively similar to the selection unit 1200 and the transmission unit 1300 of the electronic device 1000 as shown in FIG. 1. In particular, the selection unit 3200 can select at least one destination address for publishing the content data. The transmission unit 3300 transmits the content data according to the destination address selected by the selection unit 3200.

The display unit 3400 is used for displaying to the user. When the user browses a web page or watches an image or a video through the portable electronic device 3000, the display unit 3400 can display at least two parts of contents with a first effect. For example, when the user browses a web page, the display unit 3400 can display text, image and/or video on the web page with the first effect.

The acquirement unit 3100 in the present embodiment further comprises a content extraction module 3110. The content extraction module 3110 can extract the content data from the displayed at least two parts of contents. When the user performs operations of browsing a web page and watching an image or a video and so on through the portable electronic device 3000 as described above and desires to publish the currently watched whole or part of contents as the content data, the user can extract the desired part as the content data to be published through the content extraction module 3110, and then select the destination address for publishing the content data through the selection unit 3200 and transmit the extracted content data to the destination address through the transmission unit 3300.

In addition, the content extraction module 3110 can identify an extractable content that can be extracted in the at least two parts of contents displayed on the display unit 3400, so as to prompt the user the extractable part in the currently displayed picture. For example, in a case that the user finds the content desired to be published when browsing a web page including text and image, the user starts the content extraction module 3110 when desiring to publish the currently watched whole or part of contents as the content data. The content extraction module 3110 can identify the extractable content that can be extracted in the at least two parts of contents contained in the displayed webpage through for example receiving description information on the displayed picture. According to an identification result of the content extraction module 3110, the display unit 3400 can display the extractable content with a second effect and display the unextractable content that cannot be extracted in the at least two parts of contents with a third effect. The second effect and the third effect are different.

In particular, when the content extraction module 3110 identifies that there is the extractable content that can be extracted in the picture displayed on the display unit 3400, the display unit 3400 can display the extractable content according to the identification result of the content extraction module 3110 with the second effect for example highlighting border or dynamic prompt and so on, and at the same time display the unextractable content that cannot be extracted with the third effect for example covering through a transparent image and so on, such that the user can clearly know which contents in the currently displayed picture can be extracted, so as to make it convenient for selection. Alternatively, one of the second and third effects can be the same with the first display effect.

Below, a description will be given to a portable electronic device of another embodiment of the present specification by referring to FIG. 4. FIG. 4 shows an exemplary block diagram of a structure of a portable electronic device 4000 according to another embodiment of the present disclosure. As shown in FIG. 4, the electronic device 4000 comprises a publication board unit 4100, a display unit 4200 and a transmission unit 4300.

Similar to the text content establishment module 2110, the image content establishment module 2120, the audio content establishment module 2130 and the video content establishment module 2140 of the portable electronic device 2000 as shown in FIG. 2, the publication board unit 4100 comprises: a text content establishment module 4110, an image content establishment module 4120, an audio content establishment module 4130 and a video content establishment module 4140 and a selection module 4150. In alternative embodiments, the publication board unit can merely comprise one or a part of the above multiple content establishment modules.

Each content establishment module can establish a corresponding type of content data, for example, a text type of content data can be established through the text content establishment module 4110. Similarly, an image type of content data can be established through the image content establishment module 4120; an audio type of content data can be established through the audio content establishment module 4130; and a video type of content data can be established through the video content establishment module 4140. In addition, similar to the content establishment modules in the portable electronic device 2000 as shown in FIG. 2, the content establishment modules 4110-4140 further can edit the established content data.

The selection module 4150 can select at least one of destination addresses for publishing the content data. The destination address can be used to store the content data for external visits. The display unit 4200 can display to the user. The transmission unit 4300 can transmit the content data according to the destination address selected by the selection module 4250.

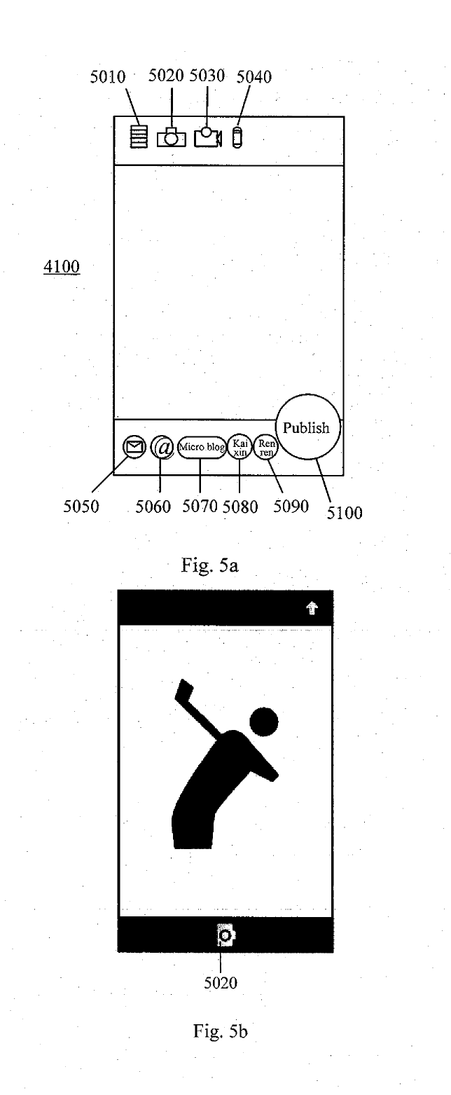

FIGS. 5a-5c shows one example of establishing an image type of content data through the image content establishment module 4120 and publishing it. FIG. 5a shown an exemplary diagram of a user interface of the publication board unit 4100 displayed on a display unit without establishing content data. FIG. 5b shows an exemplary diagram of establishing an image type of content data through the image content establishment module 4120. FIG. 5c shows an exemplary diagram of a user interface of the publication board unit 4100 displayed on the display unit in a case of having established an image type of content data. As shown in FIGS. 5a and 5c, icons 5010-5040 are respectively used for triggering the text content establishment module 4110, the image content establishment module 4120, the audio content establishment module 4130 and the video content establishment module 4140. Icons 5050-5090 are respectively corresponding to the destination addresses for publishing the content data available for the user to select in the selection module 4150. Icon 5100 is used for triggering the transmission unit 4300 to transmit the content data.

As shown in FIG. 5a, when the user starts the publication board unit 4100, there is no content data in the publication board unit 4100. Next, the user clicks the icon 5020 to make the portable electronic device open the camera and enter into a photographing interface to take a photograph as shown in FIG. 5b. Then, the user again clicks the icon 5020 so as to back to the user interface of the publication board unit 4100 as shown in FIG. 5c. As shown in FIG. 5c, the picture photographed by the image content establishment module 4120 has been put into the publication board unit 4100. Further, when the user is not satisfied with the photographed picture, he/she can delete the picture through clicking the icon 5110 above the picture. Next, the user selects, from the icons 5050-5090, destination addresses where the picture is desired to be transmitted, and clicks the icon 5100, and the transmission unit 4300 transmits the established picture one by one to the destination addresses selected by the user.

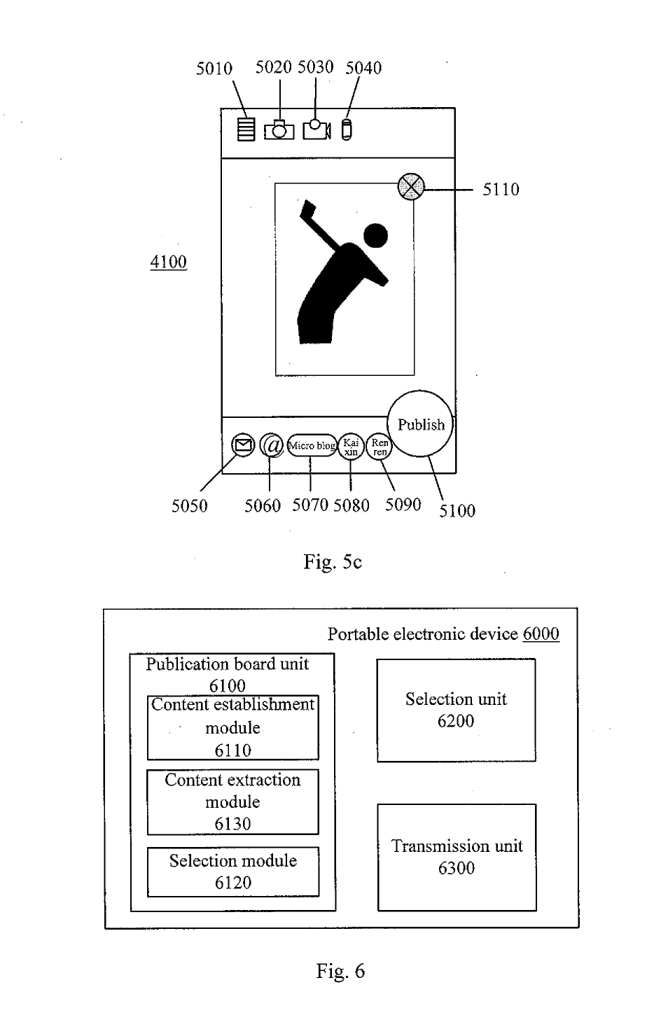

Below, a description will be given to a portable electronic device of another embodiment of the present disclosure by referring to FIG. 6. FIG. 6 shows an exemplary block diagram of a structure of a portable electronic device 6000 according to another embodiment of the present disclosure. As shown in FIG. 6, similar to the electronic device 4000, the electronic device 6000 comprises a publication board unit 6100, a display unit 6200 and a transmission unit 6300. The publication board unit 6100 comprises a content establishment module 6110 for establishing the content data and a selection module 6120 for selecting at least one destination address for publishing the content data.

The display unit 6200 can display to the user. When the user browses a web page or watches an image/video through the portable electronic device 6000, the display unit 6200 can display the at least two parts of contents with a first effect. For example, when the user browses a web page, the display unit 6200 can display the text, image and/or video on the web page with a first effect. The transmission unit 6300 can transmit the content data according to the destination addresses selected by the selection module 6120.

The publication board unit 6100 in the present embodiment further comprises a content extraction module 6130. The content extraction module 6130 can extract the content data from the displayed at least two parts of contents. When the user performs operations of browsing the web page and watching the image/video and so on through the portable electronic device 6000 as described above and desires to publish the currently watched whole or part of contents as the content data, the user can extract the desired part as the content data to be published through the content extraction module 6130, and then select the destination address for publishing the content data through the selection module 6120 and transmit the extracted content data to the destination address through the transmission unit 6300.

In addition, the content extraction module 6130 can identify the extractable content that can be extracted in the at least two parts of contents displayed on the display unit 6200, so as to prompt the user the extractable part in the currently displayed picture. Taking the case that the user browses a plurality of image files as an example, when the user desires to publish one or several of the plurality of image files displayed on the display unit 6200 as the content data, the content extraction module 6130 is started. The content extraction module 6130 can identify the extractable content in the plurality of image files through for example receiving description information on the plurality of image files displayed on the display unit 6200. According to the identification result of the content extraction module 6130, the display unit 6200 can display the extractable content with a second effect and display the unextractable content that cannot be extracted in the at least two parts of contents with a third effect.

In addition, similar to the selection unit 1200 in the portable electronic device 1000 as shown in FIG. 1, the user can select the destination addresses stored in a storage (not shown) through the selection module 6120. Alternatively, the selection module 6120 further can select at least one destination address being capable of publishing the content data according to the acquired content data. In order to avoid repetition, the operations of the selection module 6120 are not described in detail.

Similar to the above embodiment, in the alternative embodiment, the portable electronic device can further comprise a processing unit. The processing unit can process the content data according to the publishing requirements of the destination addresses selected by the selection unit. In order or avoid repetition, the operations of the processing unit are not described in detail.

In another embodiment of the present disclosure, the portable electronic device can comprise a display unit, an identification unit and a publication board unit. Similar to the display unit 6200 in the electronic device 6000, the display unit in the present embodiment can display at least two parts of the contents with a first effect. The identification unit can identify whether there is extractable content that can be extracted in the at least two parts of contents. The publication board unit can comprise: at least one content establishment module for establishing at least one type of content data and a content extraction module for extracting the content data from the displayed at least two parts of contents. When the identification unit identifies that there is extractable content in the at least two parts of contents, the publication unit enters into a first operating state; and when the identification unit identifies that there is no extractable content in the at least two parts of contents, the publication unit enters into a second operating state. In the first operation state, the display unit displays the extractable content with a second effect and displays the unextractable content in the current page with a third effect, and the content data is extracted from the extractable content through the content extraction module. And in the second operating state, at least one of the content establishment modules establishes the content data. The portable electronic device in the present embodiment can further comprise a control unit so as to control the opening and closing, and entering into the first operating state and/or the second operating state of the publication board unit.

In particular, when browsing a web page or watching an image/video and finding the content desired to be published, the user can start the publication board unit through the control unit, for example clicking the control button in the control unit to start the publication board unit. Next, the identification unit can identify whether there is extractable content that can be extracted in the web page or image/video currently browsed or watched by the user. When the identification unit identifies that there is extractable content in the web page or image/video currently browsed or watched by the user, the publication board unit enters into the first operating state. In the first operating state, the display unit displays the extractable content with the second effect and displays the unextractable content in the current page with the third effect, so as to make it convenient for the user to extract the content data from the extractable content through the content extraction module. In addition, if there is no content data in the extractable content that the user desires to extract, then the user can again click the control button in the control unit, so as to close the prepublication board unit.

On the other hand, when the identification unit identifies there is no extractable content in the at least two parts of contents, the publication board unit enters into the second operating state if the user again clicks the control button in the control unit within a predetermined time. In the second operating state, the user establishes the content data through at least one of the content establishment modules. However, if the user does not again click the control button in the control unit within the predetermined time, then the page displayed on the display unit does not change, and the publication board unit is closed. Alternatively, the publication board unit can also directly enter into the second operating state when the identification unit identifies that there is no extractable content in the at least two parts of contents.

According to another embodiment of the present disclosure, the portable electronic device can comprise: an acquirement unit, an identification unit and a display unit. The acquirement unit can acquire at least two parts of contents. The identification unit can identify extractable content that can be extracted in the at least two parts of contents acquired by the acquirement unit. The display unit can display the extractable content with a second effect, and display the unextractable content that cannot be extracted in the at least two parts of contents with a third effect. The identification unit and the display unit in the present embodiment are similar to the identification unit and the display unit in the above embodiment, details omitted for the purpose of briefness.

Through the portable electronic device according to the embodiments of the present invention, the user is able to conveniently and quickly establish or extract the content data to be published and share the above content data at multiple destinations such as information, mail, micro blog, social network and instant messaging (IM) and so on, so as to achieve a uniform establishment and publication of the published content. In addition, when making a selection of the content data, the user identifies the extractable content that can be extracted in the at least two parts of contents and prompts to the user, so as to make it convenient for the user to further perform the selection operation.

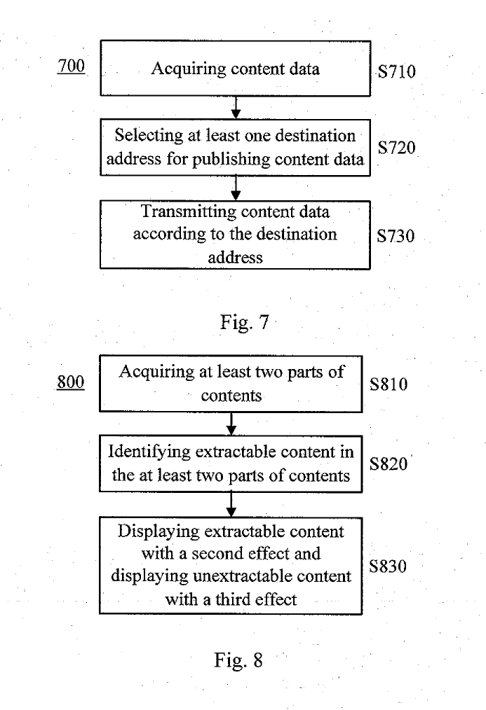

Below, a description will be given a content publishing method of an embodiment of the present disclosure by referring to FIG. 7. FIG. 7 describes a flow diagram of a content publishing method 700 according to the embodiment of the present disclosure. The content publishing method 700 can be used for the portable electronic device, and each of steps in the content publishing method 700 can be performed by the corresponding modules in the portable electronic device in the FIGS. 1-4 and FIG. 6, details omitted for the purpose of briefness.

At Step 710 in FIG. 7, content data is acquired. The user can establish at least one type of content data. Alternatively, the content data can also be extracted from a display picture. In order to make it convenient for the extracting operation of the user, the extractable content that can be extracted in the display picture is identified before the content data is extracted from the display picture, and the extractable content that can be extracted and the unextractable content that cannot be extracted in the display picture are displayed with different effects. The description information on the display picture can be received, and the extractable content in the display picture can be identified according to the description information. In addition, the extracted and/or established content data can be edited.

At Step S720, at least one destination address for publishing the content data is selected. The user can select the destination address where the established and/or extracted content data is desired to be published. Alternatively, the portable electronic device can also select at least one destination address being capable of publishing the content data according to the content data. In particular, multiple candidate destination addresses can be prestored. After the content data is established or extracted, the format information of the content data (for example the format and size of the content data) is acquired, then the format restrictions of the candidate destination addresses are read in turn and compared with the acquired content data, so as to determine whether the acquired content data exceeds the format restrictions, and the candidate destination addresses the publishing requirements of which are met by the acquired content can be displayed to the user according to the determination result. Alternatively, the candidate destination addresses the publishing requirements of which are met and the candidate destination addresses the publishing requirements of which are not met can be displayed with different display effects. For example, the candidate destination addresses the publishing requirements of which are met can be displayed with a first luminance, while the candidate destination addresses the publishing requirements of which are not met can be displayed with a second luminance, so as to make it convenient for the user to make a selection.

In addition, the content data can be further processed according to the publishing requirements of the destination address. In particular, after the user has selected the at least one destination address for publishing the content data, the format information of the established or extracted content data (for example format and size of the content data) is acquired to determine in turn whether the content in the publication board exceeds the format restrictions of the destination addresses, more particularly, determining whether the text exceeds the restrictions, respectively, removing the part of the text exceeding the restrictions and replacing with an ellipsis if the text exceeds the format restrictions; determining whether the destination address does not support a video format, automatically extracting screenshots of the video at the beginning, end and/or middle time period as the published image data if the destination address does not support the video format; determining whether a picture or a video exceeds the restrictions, compressing the picture or the video if the picture or the video exceeds the restrictions; and determining whether there is still content exceeding the restrictions, removing the part of content exceeding the format if there is content exceeding the format.

Last, at Step S730, the content data is transmitted according to the destination addresses. The destination address is used to store the content data for external visits.

Through the content publishing method according to the embodiments of the present invention, the user is able to conveniently acquire the content data to be published through the portable electronic device and share the above content data at multiple destinations such as information, mail, micro blog, social network and instant messaging (IM) and so on, so as to achieve a uniform establishment and publication of the published content. In addition, through the content publishing method of the embodiments of the present disclosure, when making a selection of the content data, the user can clearly identify the extractable content and the unextractable content; and when making a selection of the destination addresses, the user can clearly identify the candidate destination addresses the publishing requirements of which are met and the candidate destination addresses the publishing requirements of which are not met, so as to make it convenient for the user to further perform the selection operation.

Below, a description will be given to a prompting method for content selection of an embodiment of the present disclosure. FIG. 8 describes a flow diagram of a prompting method 800 for content selection according to the embodiment of the present disclosure. The prompting method 800 can be used for the portable electronic device, and each of steps in the prompting method 800 can be performed by the corresponding modules in the portable electronic device in FIGS. 3 and 6, detailed omitted.

At Step S810 in FIG. 8, at least two parts of contents are acquired. The at least two parts of contents may be a web page comprising a plurality of texts, images and/or video contents, a folder comprising a plurality of image files and so on. At Step S820, the extractable content that can be extracted in the at least two parts of contents can be identified. The extractable content that can be extracted in the at least two parts of contents can be identified through the received description information on the at least two parts of contents. Next, at Step S830, the extractable content is displayed on the display unit of the portable electronic device with a second effect, and the unextractable content that cannot be extracted in the at least two parts of contents is displayed with a third effect, so as to prompt the user the content available to be selected. For example, the second effect can be displaying the extractable content with a first transparency; and the third effect can be displaying the unextractable content with a second transparency. Or, the second effect can be displaying the extractable content with a first luminance; and the third effect can be displaying the unextractable content with a second luminance. In addition, after the at least two parts of contents are acquired, the acquired contents can be firstly displayed on the display unit with a normal display effect, then the identification operation is performed, and one of the second effect and the third effect can be the same with the normal display effect.

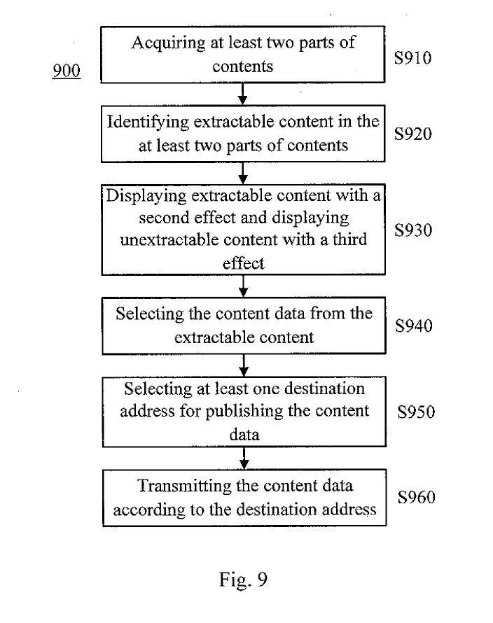

Below, a description will be given to a prompting method for content selection of another embodiment of the present disclosure. FIG. 9 describes a flow diagram of a prompting method 900 for content selection according to an embodiment of the present disclosure. Steps S910-S930 in FIG. 9 are respectively similar to Steps S810-S830 of the prompting method 800 in FIG. 8. In particular, at Step S910, at least two parts of contents are acquired. At Step 920, the extractable content that can be extracted in the at least two parts of contents is identified. Next, at Step S930, the extractable content is displayed on the display unit of the portable electronic device with a second effect, and the unextractable content that cannot be extracted in the at least two parts of contents is displayed with a third effect, so as to prompt the user the content available to be selected.

In addition, when there is extractable content in the at least two parts of contents, the prompting method 900 in the present embodiment selects the content data from the extractable content at Step S940. Next, at Step S950, at least one destination address for publishing the content data is selected, and at Step S960, the content data is transmitted according to the destination address. The destination address can be used to store the content data for external visits. In addition, the operations on the unextractable content can be prohibited.

Similar to the content publishing method 700, at least one destination address being capable of publishing the content data can be selected according to the content data. Or, the content data can be processed according to the publishing requirements of the destination address, details omitted for the purpose of briefness.

Through the prompting method of the present embodiment of the present disclosure, when making a selection of the content data, the user can clearly identify the identifiable content and the unidentifiable content, so as to make it convenient for the user to further perform the selection operation.

It should be noted that each of the steps of the methods as shown in FIGS. 7-9 is not necessarily performed according to the sequence as shown. Some steps can be performed reversely, concurrently or repeatedly. For example, the step (S710) of acquiring the content data can be performed for many times, and then the step (S720) of selecting at least one destination address for publishing the content data is performed.

Those skilled in the art can recognize that, in combination with the units and arithmetic steps of each of the examples described in the embodiments disclosed in the text, it can be achieved by an electronic hardware, computer software or a combination of the two. In order to explicitly specify interchangeability of the hardware and the software, the components and steps of each of the examples have been generally described according to the functions in the above specification. Whether these functions are performed by means of hardware or software depends on the particular applications and design constraints of the technical solutions. The special skilled persons can use different method for each particular application to implement the described functions, but such implementation should not be considered as going beyond the scope of the disclosure.

In combination with the methods or arithmetic steps described in the embodiments disclosed in the present specification. It can be implemented using hardware, software module performed by the processor or the combination of the two. The software module can be placed in an random access memory (RAM), a read only memory (ROM), an electrically programmable ROM, an erasable electrically programmable ROM, a register, a hard disk, a removable disk, a CD-ROM, or any other form of storage medium commonly known in the art.

Some embodiments of the present disclosure have been shown and described. However, those skilled in the art should understand that, various modifications can be made to these embodiments without departing from the principle and spirit of the present disclosure, and such modifications should be considered as falling into the scope of the present disclosure.

What is claimed is:

1. A portable electronic device, comprising:
a display unit for displaying to a user;
an acquirement unit for acquiring content data;
a selection unit for selecting at least one destination address for publishing the content data; and
a transmission unit for transmitting the content data according to the destination address, wherein the destination address is used to store the content data for external visits.

2. The electronic device as claimed in claim 1, wherein
the acquirement unit comprises at least one content establishment module for establishing at least one type of the content data and editing the content data.

3. The electronic device as claimed in claim 1, wherein
the display unit displays at least two parts of contents with a first effect;
the acquirement unit comprises a content extraction module for extracting the content data from the displayed at least two parts of contents.

4. The electronic device as claimed in claim 3, wherein
the content extraction module identifies extractable content that can be extracted in the at least two parts of contents, or
the content extraction module receives description information on the at least two parts of contents, and identifies extractable content that can be extracted in the at least two parts of contents according to the description information.
wherein the display unit displays the extractable content with a second effect and displays unextractable content that cannot be extracted in the at least two parts of contents with a third effect.

5. The electronic device as claimed in claim 1, wherein
the selection unit is further used for selecting at least one destination address being capable of publishing the content data according to the content data.

6. The electronic device as claimed in claim 1, further comprising:
a processing unit for processing the content data according to publishing requirements of the destination address selected by the selection unit.

7. A portable electronic device, comprising:
a publication board unit, comprising:
at least one content establishment module for establishing at least one type of content data;
a selection module for selecting at least one destination address for publishing the content data, wherein the destination address is used to store the content data for external visits.
a display unit for displaying to a user; and
a transmission unit for transmitting the content data according to the destination address selected by the selection module.

8. The electronic device as claimed in claim 7, wherein
the display unit displays at least two parts of contents with a first effect;
the publication board unit further comprises: a content extraction module for extracting the content data from the displayed at least two parts of contents.

9. The electronic device as claimed in claim 7, further comprising:
a control unit for controlling opening and closing of the publication board unit.

10. The electronic device as claimed in claim 7, wherein
the content establishment module is further used for editing the content data.

11. The electronic device as claimed in claim 8, wherein
the content extraction module identifies extractable content that can be extracted in the at least two parts of contents, or
the content extraction module receives description information on the at least two parts of contents, and identifies the extractable content that can be extracted in the at least two parts of contents according to the description information.
wherein the display unit displays the extractable content with a second effect and displays unextractable content that cannot be extracted in the at least two parts of contents with a third effect.

12. The electronic device as claimed in claim 11, wherein:
the selection unit is further used for selecting at least one destination address being capable of publishing the content data according to the content data.

13. The electronic device as claimed in claim 11, further comprising:
a processing unit for processing the content data according to publishing requirements of the destination address selected by the selection unit.

14. A prompting method for content selection applied to a portable electronic device with a display unit, comprising:
acquiring at least two parts of contents;
identifying extractable content that can be extracted in the at least two parts of contents; and
displaying the extractable content on the display unit with a second effect and displaying unextractable content that cannot be extracted in the at least two parts of contents with a third effect.

15. The method as claimed in claim 14, wherein the identifying extractable content that can be extracted in the at least two parts of contents comprises:
receiving description information on the at least two parts of contents; and
identifying the extractable content that can be extracted in the at least two parts of contents according to the description information.

16. The method as claimed in claim 14, further comprising:
prohibiting operations on the unextractable content.

17. An portable electronic device, comprising:
a display unit for displaying at least two parts of contents with a first effect;
an identification unit for identifying whether there is extractable content that can be extracted in the at least two parts of contents; and
a publication board unit, comprising:
at least one content establishment module for establishing at least one type of content data; and
a content extraction module for extracting the content data from the displayed at least two parts of contents;
wherein the publication board unit enters into a first operating state, when the identification unit identifies that there is the extractable content in the at least two parts of contents; and
the publication board unit enters into a second operating state, when the identification unit identifies that there is no extractable content in the at least two parts of contents.

18. The electronic device as claimed in claim 17, wherein
in the first operating state, the display unit displays the extractable content with a second effect and displays unextractable content in a current page with a third display effect, and the content data is extracted from the extractable content through the content extraction module.

19. The electronic device as claimed in claim 17, wherein
in the second operating state, at least one of the content establishment modules establishes the content data.

20. The electronic device as claimed in claim 17, further comprising:
a control unit for controlling opening and closing, and entering into the first operating state and/or the second operating state of the publication board unit.
